(19) United States
(12) Patent Application Publication
(10) Pub. No.: US 2023/0401631 A1
(43) Pub. Date: Dec. 14, 2023

(54) Systems and Methods for Providing Responsive Interactive Checkout User Interfaces

(71) Applicant: Shopify Inc., Ottawa (CA)

(72) Inventors: Louis McCracken, Annadale, VA (US); Sabrina Majeed, Dallas, TX (US); Robert Schlegel, Westminster, CO (US); Darren Hebner, Toronto (CA); Zanna Balarin, Santa Barbara, CA (US)

(21) Appl. No.: 17/873,810

(22) Filed: Jul. 26, 2022

Related U.S. Application Data
(60) Provisional application No. 63/346,946, filed on May 30, 2022.

(51) Int. Cl. G06Q 30/06

(52) U.S. Cl. CPC G06Q 30/0641; G06Q 30/0633

(57) ABSTRACT

Platforms for placing online orders can be slow and cumbersome for a user to navigate. There may be delays in receiving the next page from the server, increasing idling time for the user. According to some aspects of the present disclosure, an input into a user interface of a page for placing an order is compared to a condition. An indication of the input is sent by the user device to the server responsive to determining that the condition is satisfied. The response from the server is used to modify a portion of the page.

### CROSS-REFERENCE TO RELATED APPLICATIONS

This application claims the benefit of U.S. Provisional Patent Application No. 63/346,946 entitled “SYSTEMS AND METHODS FOR EXCHANGING ORDER INFORMATION BETWEEN A SERVER AND A USER DEVICE”, filed on May 30, 2022, and incorporated herein by reference in its entirety.

### FIELD

This application relates to computer user interfaces and, in particular, manners of providing responsive interactive checkout user interfaces.

### BACKGROUND

In order to purchase a product or service from an online platform, a user is typically required to enter personal information, such as their name, address and payment information. Each time the user navigates to the next step in the process, the user's device may send a request to a server for the next page to be displayed to the user. The server responds with a new page generated based on the user's information. For example, the server may respond with a page displaying shipping options determined based on the user's address and shipping rates stored at the server.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 illustrates a home page of an administrator, according to one embodiment;

FIG. 3 is a block diagram illustrating a system according to embodiments of the disclosure;

FIG. 4 is a flowchart of a method according to embodiments of the disclosure; and

FIGS. 5-10 are examples of a page for placing an order according to embodiments of the disclosure.

### DETAILED DESCRIPTION

Existing platforms for placing online orders can be slow and cumbersome for a user to navigate. There may be delays in receiving the next page from the server, increasing idling time for the user. In addition, if a user wishes to change information entered earlier in the checkout process, they may need to navigate back through previous pages to re-enter their information, necessitating additional requests to the server to retrieve earlier pages.

According to some aspects of the present disclosure, an input into a user interface of a page for placing an order is compared to a condition. The condition may indicate whether or not the input is well-formed. An indication of the input is sent by the user device to the server responsive to determining that the condition is satisfied. In some embodiments, a response from the server may then be received. The response may be used to modify a portion of the page.

By sending an indication of the input to the server responsive to the condition being satisfied, communication overhead between the user device and the server can be reduced by reducing the risk of invalid inputs being received at the server. In addition, sending the indication to the server when the condition is satisfied can reduce idling time which may otherwise arise whilst waiting for an explicit submission by a user. Modifying a portion of the page allows for progressing the user through the checkout process without the need to request a new page from the server. This can further reduce idling time and network overhead. Aspects of the disclosure thus provide a more efficient and responsive page for placing an order.

In some embodiments, there is provided a computer-implemented method. The method may include receiving, by a user device from a server, content corresponding to a page for placing an order. The content may include instructions for providing a user interface for receiving information related to the order. The content may define one or more conditions associated with the user interface. The method may further include rendering, by the user device, the page for display on a display associated with the user device. The rendered page includes the user interface. The method may further include receiving information via the user interface and determining, by the user device, that the information satisfies at least one condition of the one or more conditions. The method may further include responsive to the information satisfying the at least one condition of the one or more conditions, sending, by the user device to the server, an indication based on the received information. The method may further include receiving, by the user device from the server, a response responsive to the indication. The method may further include modifying, by the user device, at least a portion of the rendered page based on the received response.

In some embodiments, the at least one condition may comprise the information having a particular format. The particular format may comprise at least one of: a particular number of characters, a particular type of one or more characters, or a position of a particular type of character in the information. In some embodiments, the response from the server may indicate that the information is invalid and modifying the portion of the page may comprise modifying the portion of the page to prompt the user to change the information. In some embodiments, the information may be entered into a first user interface control displayed on the page and modifying the portion of the page may comprise modifying the portion of the page to display a second user interface control on the page. The first user interface control may comprise a text entry field and the information entered may be entered into the text entry field. In some embodiments, modifying the portion of the page to display the second user interface control on the page may comprise changing a focus of the page to the second user interface control. In some embodiments, the at least one condition of the one or more conditions may be based on data from the user device. In some embodiments, the information may comprise address information. In some embodiments, the information may be entered into a user interface control displayed on the page, and the method may further comprise, responsive to sending the indication to the server, preventing change of the information entered into the user interface control until the response is received. In some embodiments, the information is entered into a first user interface control displayed on the page and the method may further comprise, responsive to the information satisfying the at least one condition of the one or more conditions, changing a focus of the page to a second user interface control on the page. In some embodiments, the content may comprise web content and the page may comprise a web page.

In another embodiment, there is provided a computer readable medium having stored thereon computer-executable instructions that, when executed by a computer, cause the computer to the perform operations of the methods disclosed herein. The computer may be associated with the user device, and execution of the instructions by the computer may cause the user device to perform the operations of the user device described herein.

A system is also disclosed that is configured to perform the methods disclosed herein. For example, the system may include at least one processor to directly perform (or instruct the system to perform) the method steps.

For illustrative purposes, specific example embodiments will now be explained in greater detail below in conjunction with the figures.

An Example E-Commerce Platform

Although integration with a commerce platform is not required, in some embodiments, the methods disclosed herein may be performed on or in association with a commerce platform such as an e-commerce platform. Therefore, an example of a commerce platform will be described.

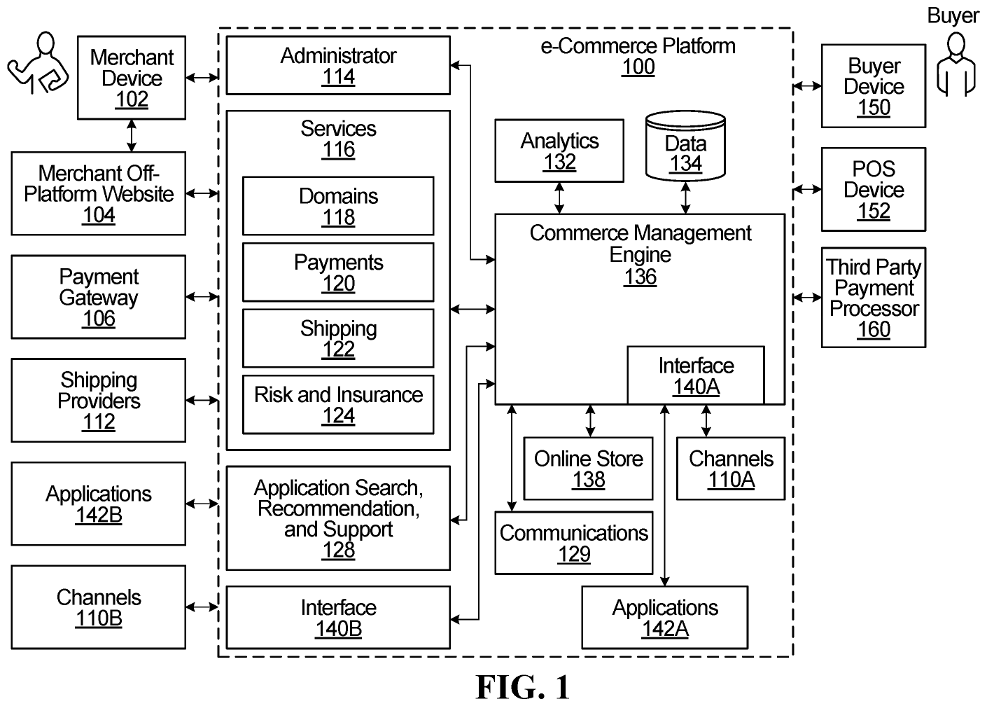

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100.

Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B , channels 110A-B, shipping providers 112, customer devices 150, point of sale devices 152, etc.. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

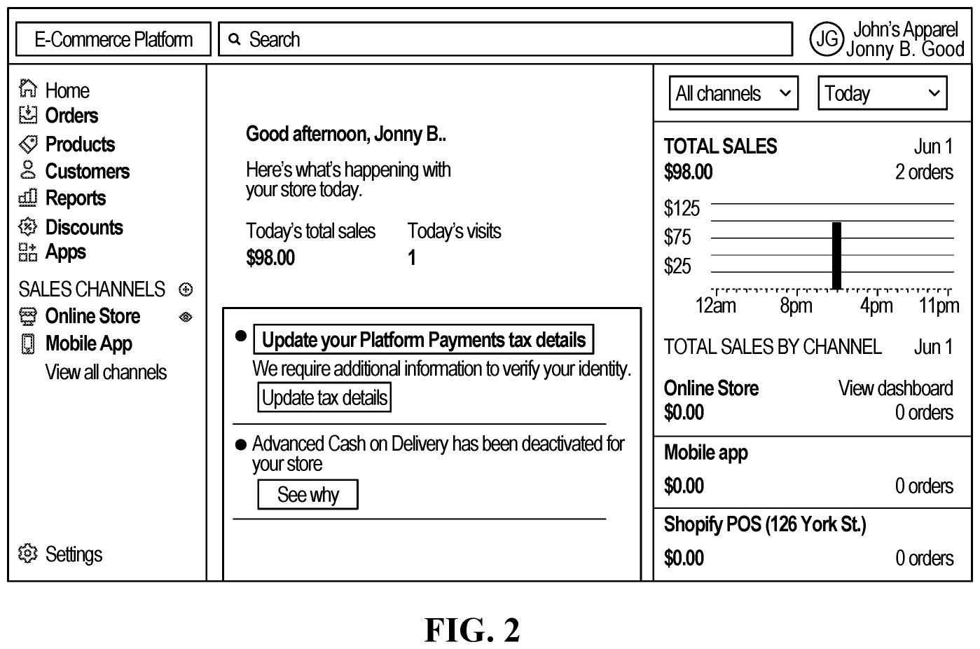

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like.

Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Exchanging Order Information Between a User Device and the E-Commerce Platform 100

A customer may use the customer device 150 to place an order at the merchant's online store 138. An application (e.g., a browser) on the customer device 150 may connect to the online store 138 to receive content which may be rendered at the customer device 150 to display pages for placing an order. The customer may place an order by navigating through a series of pages displayed on the customer device 150. Each time the customer navigates to a subsequent page, the customer device 150 may send information entered by the customer to the online store 138 and request the next page. The online store 138 may respond with a new page generated using the information received from the customer device 150. For example, the online store 138 may respond with a page for displaying shipping options, in which the shipping options are generated based on address information entered by the customer.

This process can be slow and cumbersome for the customer to navigate. Since information is only sent to the online store 138 when the customer navigates to the next page, the customer device 150 may be left idle whilst waiting for the online store 138 to respond with the next page. If the customer inputs invalid or incorrect information, the customer may be delayed further as the online store 138 may respond with a first page requesting valid input and only return the next page once valid input is provided.

In an alternative approach, the customer device 150 may constantly monitor the information entered by the user and send the information to the online store 138 as it is entered. However, this would require maintaining a continuous data stream between the customer device 150 and the online store 138, which risks incurring significant network overhead.

According to aspects of the disclosure, the customer device 150 may display, on a display associated with the customer device 150, a page for placing an order. The customer device 150 may receive information entered into the page and, responsive to the information satisfying at least one condition, send an indication of based on the information to the e-commerce platform 100 or a part of the e-commerce platform 100. Based on the response from the e-commerce platform 100 or a part of the e-commerce platform 100, the customer device 150 may modify at least a portion of the page.

By sending the indication responsive to the information satisfying at least one condition, the customer device 150 may use the information entered by the user to determine that the user has finished entering information (and possibly determine that the information is well-formed), and in response thus send the information. This reduces any idling time that might otherwise arise whilst waiting for the user to explicitly submit the information whilst minimising network overhead. By modifying at least a portion of the page based on the response, the user can be progressed through the process of placing an order without necessitating reloading the entire page. This further reduces network overhead.

Although the embodiments described herein may be implemented in relation to e-commerce platform 100, the embodiments are not limited to the e-commerce platform 100 of FIGS. 1 and 2 and could be used in connection with any platform in which an order is being placed. Therefore, the embodiments below will be described more generally.

Example System for Exchanging Order Information

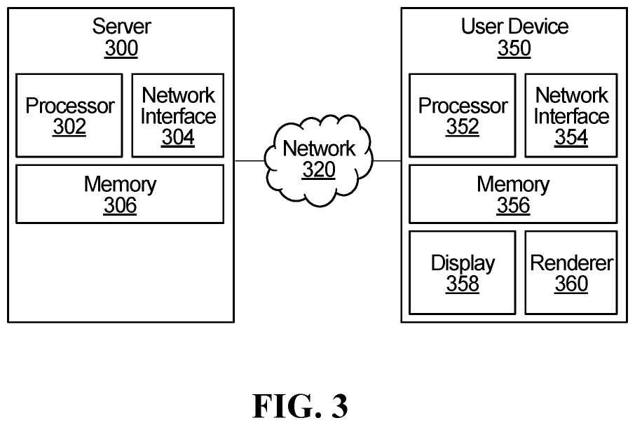

FIG. 3 is a block diagram illustrating a system according to embodiments of the disclosure. The system includes a server 300 and a user device 350. The server 300 is connected to the user device 350 by a network 320.

The server 300 may include or be a part of an e-commerce platform, such as the e-commerce platform 100. Although only one user device 350 is illustrated, the server 300 may, in general, be connected to one or more user devices. The server 300 includes a processor 302, network interface 304 and a memory 306. The processor 302 performs, or instructs the server 300 to perform, the operations described herein of the server 300. The processor 302 may be implemented by one or more general purpose processors that execute instructions that may be stored in a memory (e.g., the memory 306) or stored in another computer-readable medium. The instructions, when executed, may cause the processor 302 to directly perform, or instruct the server 300 to perform, the operations described herein. In other embodiments, the processor 302 may be implemented using dedicated circuitry, such as a programmed field programmable gate array (FPGA), a graphics processing unit (GPU), or an application specific integrated circuit (ASIC).

The network interface 304 is for communicating over the network 320 (e.g., to communicate with the user device 350). The network interface 304 may be implemented as a network interface card (NIC), and/or a computer port (e.g., a physical outlet to which a plug or cable connects), and/or a network socket, etc., depending upon the implementation.

The server 300 further includes the memory 300. A single memory 300 is illustrated in FIG. 3, but in implementation the memory 300 may be distributed.

In some embodiments, the server 300 may be implemented inside of an e-commerce platform (e.g., inside e-commerce platform 100). For example, the server 300 may be implemented in (or in association with) the online store 138. In some embodiments, the processor 302, memory 306, and/or network interface 304 may be located outside of the server 300.

The user device 350 may be the customer device 150. The user device 350 comprises a processor 352, a network interface 354, a memory 356, a display 358 and a renderer 360. The processor 352 performs, or instructs the user device 350 to perform, the operations described herein of the user device 350. The processor 352 may be implemented by one or more general purpose processors that execute instructions stored in a memory (e.g., the memory 356) or stored in another computer-readable medium. The instructions, when executed, may cause the processor 352 to directly perform, or instruct the user device 350 to perform, the operations described herein. In other embodiments, the processor 352 may be implemented using dedicated circuitry, such as a programmed FPGA, a GPU, or an ASIC.

The network interface 354 is for communicating over the network 320 (e.g., to communicate with the server 300). The structure of the network interface 354 will depend on how the user device 350 interfaces with the network 320. For example, if the user device 350 is a wireless device (e.g., a mobile phone, laptop, or tablet), the network interface 354 may comprise a transmitter/receiver with an antenna to send and receive wireless transmissions to/from the network 320. If the user device 350 is a wired device such as personal computer connected to the network 320 with a network cable, the network interface 354 may comprise a NIC, and/or a computer port (e.g., a physical outlet to which a plug or cable connects), and/or a network socket, etc.

The user device 350 further includes the memory 356. A single memory 356 is illustrated in FIG. 3, but in implementation the memory 356 may be distributed.

The user device 350 further includes a display 358. The display 358 is for presenting information to a user. The display 358 may be implemented as a display screen, such as a touchscreen. Although the display 358 is illustrated as being part of the user device 350, in some embodiments the display 358 may be associated with (e.g., connected to) the user device 350.

The user device 350 is further associated with at least one input device (not illustrated). The at least one input device may include at least one of: a touchscreen (e.g., integrated in the display 358), a touchpad, a mouse, a keyboard and/or any other suitable input device. One or more of the at least one input device may be integrated in the user device 350. One or more of the at least one input device may be connected to the user device 350.

The user device 350 further comprises a renderer 360. The renderer 360 is to (e.g., is configured to) render a page for placing an order, in which the page is to be displayed on the display 358 based on one or more instructions. The renderer 360 may be implemented in an application (e.g., a browser, web application or native application) on the user device 350. The application may be implemented by the processor 352, for example. Therefore, although shown separately from the processor 352, the renderer 360 may be implemented by the processor 352.

Example Processes for Exchanging Order Information

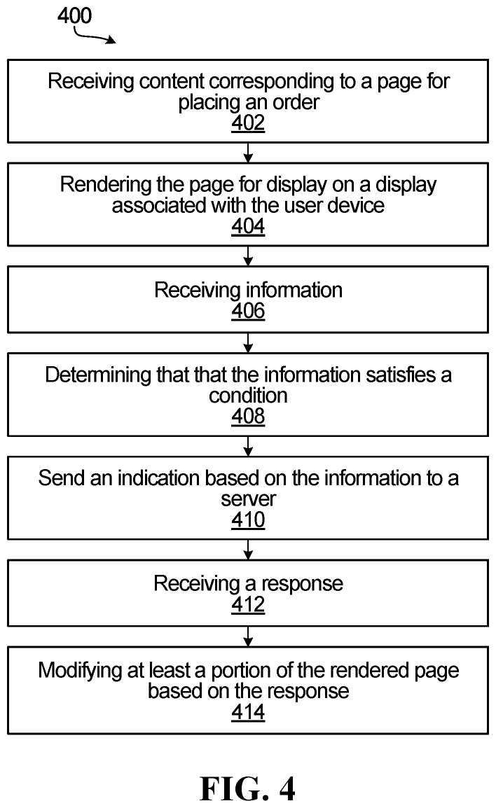

FIG. 4 illustrates a computer-implemented method 400 according to one embodiment. Not all of the steps in the method 400 are necessary in all embodiments. Also, some of the steps may be substituted by other steps instead.

In the method 400, the steps are described as being performed by the user device 350 of FIG. 3, but this is only an example. For example, the method 400 may instead be performed by another entity, which may or may not be a user device. The steps of the method 400 are also described with reference to the server 300, but this is only an example. In general, any entity may take the place of the server 300 in the method 400, and the entity may or may not be a server.

At step 402, the user device 350 receives content corresponding to a page for placing an order. The page may be for placing an order for one or more products and/or services, for example. The page may be a web page (e.g., for display by a browser or other web application in the user device 350). More generally, the page may include an aspect of the application that is continuously presented on the display of the user device 350 for a period of time (e.g., without being refreshed or reloaded). In some embodiments, the page may be or comprise the content rendered on display 358 by an application, where the application may be web-based (in which case the page may be a webpage) or the application may be a native application to the user device that is not necessarily web-based. If the application is web-based, then the application may be or comprise a browser.

The content may be received from the server 300 (e.g., via the network interface 354). The content may be received from the server 300 in a web message (e.g., a Hypertext Transfer Protocol, HTTP, message or HTTP Secure, HTTPS, message). The content may be received from the server 300 on request. For example, the user device 350 may receive, from the user, an indication that the user wishes to place an order (e.g., the user may click a “Go to Checkout” button on a previous page). Responsive to the indication, the user device 350 may send a request to the server 350 for the page for placing the order. For example, the user device 350 may send a web request (e.g., a HTTP request or a HTTPS request) to the server 350 and receive the content in a web response (e.g., a HTTP response or a HTTPS response).

In another example, the content may be stored at the user device 350. The user device 350 may thus, for example, retrieve the content from a memory at the user device 350 (e.g., the memory 356). The content may be retrieved from the memory responsive to receiving, from the user, an indication that the user wishes to place an order.

The content includes instructions for providing the page. In some examples, the content may be web content and the page may be a web page. For example, the instructions may include HTML defining the web page. The instructions may further comprise Cascading Style Sheets (CSS), template language, JavaScript, and the like, and/or any combination thereof. The CSS may define the appearance of one or more elements of the web page. The JavaScript may define the functionality of one or more elements of the web page. In general, the content may be readable by an application implemented at the user device 350 (e.g., browser, web application or a native application), such as an application implementing the renderer 360.

The page is for receiving, from the user, information related to the order. The page may be described as comprising a user interface for this purpose. The user interface (and thus the page) may include one or more user interface controls for receiving information from the user. The one or more user interface controls may be referred to as fields or inputs. In general, a user interface control may comprise an element for receiving information entered by a user such as, for example, a text field (e.g., a text input field), a radio button, a checkbox, a timepicker, a datepicker (e.g., a calendar with selectable dates), or a list/array (e.g., a dropdown list) with selectable entries. The user interface may thus comprise parts of the page into which the user may enter (or input) information.

The page may be based on stored information associated with the user. The stored information may form part of a user profile (e.g., specific to the user). The stored information may, for example, be retrieved from an application or service which stores the user profile. The stored information may form part of a session profile. The session profile may comprise information generated and/or collected during a period of activity at the user device 350 (e.g., a period in which the user interacts with one or more applications at the user device 350). The stored information may be stored at the user device 350, the server 300 and/or elsewhere (e.g., at another server, application or service). The stored information may be stored in any suitable form. In some examples, the stored information may comprise one or more cookies stored at the user device 350.

The stored information may comprise any information relevant to placing an order. The stored information may include, for example, one or more of: a name of the user, address information (e.g., a building number, street, county province or state, country and/or postal code), payment information (e.g., bank card details, credit card details, details for a payment method or payment account), a discount code (e.g., entitling the user to a reduced price on their order), a donation amount (e.g., as a percentage of the order total or absolute value), or a tip amount (e.g., as a percentage of the order total or absolute value). The address information may be for a billing address and/or a delivery address.

The stored information may indicate a preference of the user. For example, the stored information may indicate a payment method that is preferred by the user. In another example, the stored information may indicate a delivery address that is preferred by the user. In another example, the stored information may indicate a tip amount that is preferred by the user.

The stored information may be a session identifier for identifying a session, which may be generated by the user device 350, the server 300, and/or elsewhere. Additionally or alternatively, the session information may be information previously entered by the user (e.g., into a user interface control of another page). Alternatively or additionally, the stored information may have been generated or collected based on user activity. For example, the stored information may include a discount code based on the user navigating to a particular website from a referral website.

The stored information may be associated with (e.g., related to) the user in any suitable way. In some examples, the user may be logged into an account at the user device 350 and the stored information may be associated with the account. For example, the stored information may form part of a user profile associated with the account. The account may be for placing the order. For example, the account may be for an application which is being used, at the user device 350 to place the order. The account may be, for example, for a payment application or service (e.g., a digital wallet). Alternatively or additionally, the account may be for an application or service (e.g., a third party application) that has a purpose other than order placement. For example, the user may be logged into an account for a communication service (e.g., email, messaging, calls, a social medium etc.) and information associated with the user may be retrieved from the communication service.

In some examples, the stored information may indicate that the user is logged into an account. The stored information may thus indicate a user's logged-in state. This may indicate that the user (or the user device 350) has an ongoing session with a particular application or service, for example.

In some examples, the stored information may be associated with the user even if the user is not logged into an account at the user device 350. The stored information may be collected and stored (e.g., at the user device 350) as the user interacts with the user device 350.

The page may display the stored information associated with the user. Thus, the page may be populated with stored information from a profile of the user. The page may, additionally or alternatively, omit one or more first user interface controls that would otherwise be presented for receiving the stored information associated with the user. For example, the stored information may include address information for the user and thus the page might not include a first user interface control for the user to enter address information. Omitting the one or more first user interface controls that would otherwise be presented for receiving the stored information associated with the user may be particularly advantageous for user devices with small displays, as it may free up space on the display for other information and/or other user interface controls.

In some examples, rather than omitting the one or more first user interface controls from the page, the one or more first user interface controls may be deactivated (e.g., such that information cannot be entered into them). For example, a text entry field in the page may be filled with address information and the page may prevent the address information from being changed or deleted. In some examples, the page may display the stored information, omit or deactivate the one or more first user interface controls that would otherwise be presented for receiving the information associated with the user, and present a second user interface control which, when activated, displays or activates the one or more first user interface controls to allow the user to edit or delete the stored information. For example, the page may include an “Edit” button which, when clicked, activates a deactivated text entry field to allow the user to enter information into the text entry field.

In some examples, the presence, position, size and/or appearance of one or more elements of the page may be based on the stored information associated with the user. Thus the layout of the page may be based on the stored information associated with the user. For example, the stored information associated with the user may be displayed at a first part of the page (e.g., the top of the page) and the focus of the page may be another part of the page (e.g., the bottom of the page). The focus of the page may include a user interface control for entry, by the user, of other information. In this way, the attention of the user may be directed towards entering information that is not otherwise available to the user device 350 and/or the server 300.

By basing the page on stored information associated with the user, re-entry of information associated with the user can be avoided. This can reduce the number of interactions between the user and the user device 350 (e.g., by minimising the number of clicks), which may be particularly advantageous for user devices with small or otherwise difficult to use input devices (e.g., user devices with small touchscreens). Avoiding re-entry of stored information can also allow for progressing the user through checkout more quickly and efficiently, as it may effectively allow for automatically progressing a user through checkout states.

The page may be based on stored information associated with the user because the content is based on the stored information associated with the user. Thus, for example, the instructions included in the content may be based on the stored information associated with the user. The user device 350 may, for example, receive the content including instructions for providing the page from the server, in which the server 300 determined the instructions based on the stored information associated with the user. The server 300 may, for example, indicate in the instructions to omit and/or deactivate the one or more first user interface controls based on the stored information associated with the user. In other examples, the user device 350 may select the content from the memory at the user device 350 (e.g., as described above) based on the stored information associated with the user. For example, the user device 350 may select the content comprising instructions for generating a page which includes a user interface control for receiving address information responsive to determining that the stored information associated with the user does not include address information.

Additionally or alternatively, the page may be based on stored information associated with the user because the rendering of the page is based on the stored information associated with the user. This is described in more detail below.

The content may define one or more conditions associated with the user interface. The one or more conditions are discussed in more detail below.

At step 404, the user device 350 renders the page for display on the display 358. The renderer 360 may render the page, for example.

An example process for rendering, by the renderer 360, the page is provided. In this example the page is a web page. The instructions comprise HTML and CSS. The renderer 360 generates a document object model (DOM), or DOM tree, based on the HTML (e.g., by parsing the HTML), and a CSS Object Model (CSSOM) based on the CSS. The DOM defines one or more elements that form part of the page. The CSSOM may comprise, for example, style information to be applied to at least one of the one or more elements defined in the DOM (e.g., elements to be displayed as part of the web page). The CSSOM may, for example, specify that a header referred to in the DOM should be displayed with a font size of 14 pixels and a color gray.

The renderer 360 further generates a tree (e.g., RenderTree) using the DOM and the CSSOM. The tree may comprise a representation of the web page. Thus, for example, the tree may comprise only elements from the DOM which are to occupy space on the display 358 (e.g., omitting elements such as <title> which are not conventionally displayed). Using the tree, the renderer 360 determines the layout of the web page. Determining the layout of the web page may include determining a position and size (e.g., the dimensions) of each of the elements of the web page. Determining the layout may alternatively be referred to as reflow or browser reflow, for example.

Based on the layout, the renderer 360 adds (e.g., paints or prints) the one or more elements to the web page, where they appear on the display 358.

For example, the renderer 360 may create one or more layers comprising visual representations of the elements forming the web page. The elements may be included in a single layer or distributed across multiple layers. Multiple layers may be particularly useful in examples in which the elements of the web page overlap. The renderer 360 may fill in one or more pixels of each layer in accordance with the appearance, position and size of the one or more elements in the respective layer as specified by the layout and/or the tree. The process of filling each of the layers may be referred to as rasterization. The renderer 360 may further send the one or more layers to the processor 352 to draw on the display 358, which may be referred to as compositing. The processor 352 may, for example, comprise a graphical processing unit (GPU) which causes the one or more layers to be shown on the display 358.

Although the aforementioned example refers to rendering a web page, the skilled person will appreciate that the present disclosure is not limited as such. In general, the operations performed to render a page may vary depending on instructions, the type of page, and/or the implementation of the renderer 360. As such, one or more of the aforementioned operations may be omitted and/or the order of the operations may differ from the description provided above.

In general, rendering the page at step 404 may comprise identifying, from the instructions, one or more elements to be displayed on the page, determining a position, size and/or appearance of the one or more elements from the instructions and displaying the one or more elements to cause the page to appear on the display 358.

The rendered page may include the user interface. Rendering the page at step 404 may comprise displaying, on the display 358, one or more user interface controls for receiving information from (e.g., entered by) the user.

As mentioned above, user device 350 may render the page based on stored information associated with the user (e.g., information stored in a user profile). The presence, position, size and/or appearance of one or more elements from the instructions may be determined based on stored information associated with the user. For example, the user device 350 may display a user interface control for receiving information from the user as being populated with information from a user profile. This may implicitly indicate to the user that they do not need to re-enter the information. In another example, the user device 350 might not, in step 404, display a particular user interface control for receiving particular information from the user responsive to determining that the particular information is included in the stored information associated with the user (e.g., is included in a user profile).

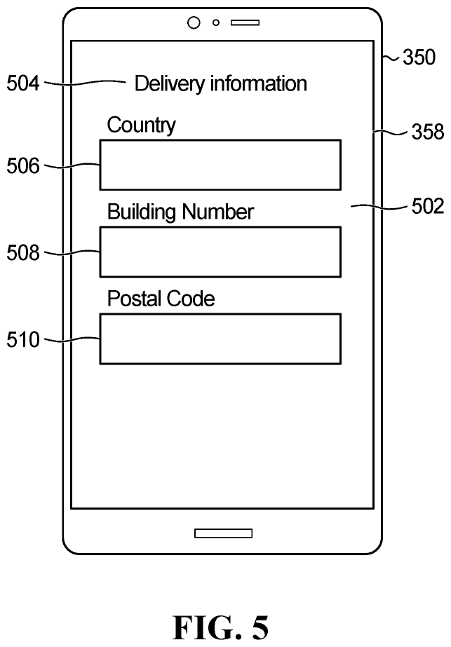

FIG. 5 shows an example of a rendered page 502 on the display 358 of the user device 350. The skilled person will appreciate that the user device 350 illustrated in FIG. 5 is an example implementation of the user device 350 and, in general, the user device 350 may be any suitable user device 350.

The page 502 comprises a plurality of elements 504-510. The plurality of elements 504-510 comprise a header 504, and three user interface controls 506-510. The header 504 contains information displayed to the user which, in this case, is “Delivery information”.

The user interface controls 506-510 are for receiving information entered by the user. The user interface controls 506-510 may instead be referred to as inputs or fields, for example. As illustrated, each of the user interface controls 506-510 may have an associated sub-header indicating the information to be received via the respective user interface control 506-510. The sub-headings for the respective user interface controls 506-510 in this example are “Country”, “Building number” and “Postal code”.

The first user interface control 506 comprises a dropdown list of a plurality of countries from which the user may select a country. Thus, for example, the user may select the first user interface control 506 on the display 358 to cause a list (e.g., a scrollable list) of countries to appear. The user may select a country from the list, causing the selected country to appear in the first user interface control 506.

The second and third user interface controls 508, 510 comprise text entry fields into which a user can enter text (e.g., characters such as letters, numbers and/or symbols). As illustrated by the associated sub-headings, the second user interface control 508 is for receiving a building number (e.g., a unit number, a house or apartment number) and the third user interface control 510 is for receiving a postal code (e.g., a ZIP code or postcode).

Returning to FIG. 4, at step 406, the user device 350 receives information via the user interface. The user may enter the information into the user interface using one or more input devices associated with the user device 350. The processor 352 may thus receive the information via the one or more input devices. The one or more input devices may be comprised in or connected to the user device 350. For example, the user device 350 may comprise a touchscreen and the information may be entered into the user interface using the touchscreen. In another example, the user device 350 may be connected to a keyboard and a user may use the keyboard to enter the information into the user interface.

The information may be any information suitable for placing an order. The information may, for example, comprise one or more of: address information (e.g., a building number, street, county province or state, country and/or postal code), payment information (e.g., bank card details, credit card details, selection of a payment method or payment account, login details for a payment method or payment account), a discount code (e.g., entitling the user to a reduced price on their order), a donation amount (e.g., as a percentage of the order total or absolute value), or a tip amount (e.g., as a percentage of the order total or absolute value).

The information may be entered into a first user interface control on the page (e.g., a first user interface control of the user interface). The form of the information entered into the first user interface control may depend on the type of user interface control. For example, the first user interface control may comprise a text entry field and the information may comprise one or more characters (e.g., numbers, letters and/or symbols). In another example, the first user interface control may comprise a plurality of checkboxes, and the information may indicate which of the checkboxes are selected by the user.

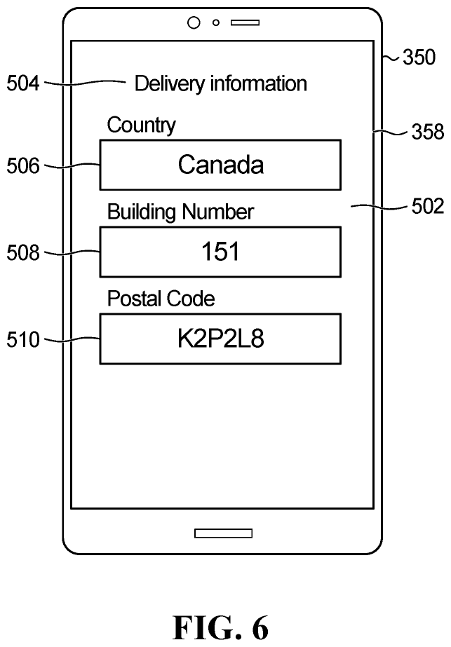

For the example page 502 described above in respect of FIG. 5, the user may enter information by selecting a country (“Canada”) using the first user interface control 506, (e.g., using the dropdown list), entering a building number “151” into the second user interface control 508 and entering a postal code “K2P2L8” into the third user interface control 510 to result in page 502 as shown in FIG. 6. The user device 350 may thus receive the information entered by the user (“Canada”, “151” and “K2P2L8”).

The user device 350 may compare at least some of the information to at least one of the one or more conditions. As described above, the content may define the one or more conditions (or a portion thereof). Alternatively or additionally, the user device 350 may receive the one or more conditions (or a portion thereof) separately from the content (e.g., in another message). For example, the user device 350 may receive some or all of the one or more conditions after receiving the content. The user device 350 may receive some or all of the one or more conditions on request. For example, the user device 350 may send a request to the server 300 and receive, in response, the one or more conditions. In a further alternative, the one or more conditions may be stored at the user device 350 (e.g., in the memory 356). The user device 350 may, for example, retrieve the one or more conditions from the memory 356.

In step 408, the user device 350 determines that the information satisfies at least one of the one or more conditions. The user device 350 may thus compare some or all of the information entered by the user to the at least one condition and determine that the at least one condition is satisfied.

Each of the one or more conditions may be associated with one or more user interface controls in the page. A respective condition may indicate, for a corresponding user interface control, that a user has finished entering information and/or that the information entered is well-formed, for example. User interface controls for a page for placing an order may be for receiving information that has an expected or known format. For example, a user interface control may be for receiving a telephone number, which may be known to have a particular number of digits. In another example, the user interface control may be for receiving a postal code, which may be known to be formed from a particular combination of digits and/or letters in a particular order. A respective condition may thus indicate whether or not information entered into a corresponding user interface control is complete and/or well-formed. Complete may refer to the information having the right quantity and/or type of characters. Well-formed may refer to the information having a particular format that is mandated, e.g., a postal code having six characters alternating between letters and numbers.

In some examples, the at least one condition may specify the information having a particular format. The particular format may specify a template for the information, for example. The particular format may comprise at least one of: a particular number (quantity) of characters, a particular type of one or more characters, or a position of a particular type of character in the information. This may be particularly appropriate in examples in which the first user interface control comprises a text entry field, for example.

In the example of the page 502 described in respect of FIGS. 5-6, the one or more conditions may include a first condition specifying that information entered into the third user interface control 510 is to have six characters. The user device 350 may, for example, compare the information entered by the user into the third user interface control 510 (e.g., “K2P2L8”) in the page 502 to the first condition. Since the user entered “K2P2L8”, which has six characters, the user device 350 may determine that the first condition is satisfied. In another example, the condition may be more specific or detailed, e.g., the condition in the postal code example may be that the information must consist of six characters, alternating between letter and number, with the first character being a letter.

In examples in which the first user interface control comprises a plurality of selectable elements (e.g., checkboxes, dates in a datepicker, elements in a list such as a dropdown list, radio buttons, and/or times in a timepicker), the at least one condition may indicate a threshold number (e.g., a minimum number) of elements to be selected. The user device 350 may thus determine that the at least one condition is satisfied responsive to determining, based on the information, that the number of elements selected by the user satisfies the threshold number (e.g., is greater than or equal to the minimum number). In particular examples, the condition may indicate that one element has been selected. This may be particularly appropriate for radio buttons since radio buttons are typically used to present mutually exclusive options to a user. As such, selecting one radio button may indicate that the user has completed entering information into the respective first user interface control. For example, the at least one condition may indicate that one of multiple delivery additions is selected. In another example, the at least one condition may indicate that one of multiple tip or donation amounts is selected.

In some embodiments, at least one of the one or more conditions may be based on data from the user device 350. The user device 350 may send data to the server 300 and receive, in response, the at least one condition based on the data. Alternatively or additionally, the user device 350 may select the at least one condition from a plurality of conditions (e.g., received from the server 300) based on the data.

The data may comprise the stored information associated with the user described above. Thus, for example, the data may comprise information stored in a profile of the user. For example, the user may be logged into an account at the user device 350 and the data may comprise information from a profile associated with the account.

The data may comprise information entered by the user. The data may comprise information previously entered by the user into a user interface control of the page, for example. The data may comprise information entered by the user into a user interface control of a different page (e.g., a page previously shown on the display 358). In the example described above in respect of FIGS. 5-6, the user device 350 may send the country (“Canada”) to the server 300 when it is entered by the user and receive, in response, a second condition based on the country. The second condition may specify a particular format for the postal code for the country. For example, the second condition may specify that the postal code received via the third user interface control 510 for the country indicated via the first user interface control 506 is to have the format A1A1A1, in which each instance of A may be any letter and each instance of 1 may be any digit.

In some examples, the data may be obtained by the user device 350 without explicit input from the user. The data may comprise operation information for the user device 350, for example, such as an internet protocol (IP) address of the user device 350. In some examples, data from the user device 350 may comprise (or be used to determine) an indication of the location of the user device 350. For example, the data may comprise one or more of: an internet protocol (IP) address of the user device 350, one or more geographical coordinates (e.g., obtained by a Global Navigation Satellite System sensor, such as global positioning system (GPS) sensor in the user device 350), and/or a region (e.g., a country, state or province) in which the user device 350 is located. Thus, for example, the at least one condition may comprise a particular format for address information (e.g., a postal code) based on a location of the user device 350 determined from the IP address of the user device 350. In some embodiments, the data is extracted from the request from the user device, e.g., from a web request such as from an HTTP or HTTPS request sent from the user device. For example, the IP address associated with the user device may be extracted from the web request for the page for placing the order. Using the IP address, a location of the user may be determined (e.g., by mapping the IP address to a particular region). A particular condition may then be sent to the user device as part of the content, where the particular condition corresponds to (e.g., is specific to and/or unique to) the location determined from the extracted IP address. Instead of or in addition to an IP address, other data may be extracted from the request to determine a location, e.g., GPS or region data, as discussed above.

In some embodiments, step 408 may comprise determining that the information satisfies more than one condition. Any suitable combination of conditions may be used (e.g., any combination of the conditions described above). Thus, for example, step 408 may comprise determining that the information comprises six characters (a first condition) and all of the characters in the information are numbers (a second condition).

In some embodiments, step 408 may comprise comparing information entered into more than one user interface control to at least one condition. Step 408 may comprise comparing information entered into a plurality of user interface controls to a plurality of conditions. In the example described above in respect of FIGS. 5-6, the user device 350 may, for example, compare information entered into the second user interface control 508 (“151”) to a first condition and information entered into the third user interface control 510 (“K2P2L8”) to a second condition and determine that both conditions are satisfied. This may be particularly appropriate when multiple pieces of information are needed from the user in order to progress placement of the order.

In step 410, responsive to the information satisfying the at least one condition of the one or more conditions, the user device 350 sends, to the server 300, an indication based on the received information. The indication may comprise some or all of the information. For example, the user device 350 may send the information received in step 406. The indication may comprise a parameter determined based on the received information. For example, the information may comprise a tip value as a percentage of the order price and the indication may comprise the absolute value of the tip. In another example, the indication may comprise an abbreviation of the information. For example, the user may enter the country “Canada” and user device 350 may determine an abbreviation “CA” of the entered country.

The indication may be based on the received information and the stored information associated with the user described above. In some examples, the indication may be based on the received information and information from a profile of the user. For example, a profile of the user that is available to both the user device 350 and the server 300 may indicate address information that was previously used by the user and the received information may comprise the same address information. The user device 350 may thus, rather than sending the address information, send an indication that the address information is the same as stored in the user profile. This may reduce the amount of data that is transmitted between the user device 350 and the server 300.

Step 410 may further comprise sending other information entered into the user interface. Thus, for example, the page may comprise one or more further user interface controls in addition to the first user interface control, and the user device 350 may send, to the server 300, information received via one or more further user interface controls in addition to the indication. In particular examples, step 410 may comprise sending all information entered by the user into the user interface (e.g., all of the information entered by the user to place the order). It may be particularly advantageous to send all information previously entered by the user (e.g., the entire checkout state) to the server 300 as this may reduce the risk of malicious intervention.

In the example described in respect of FIGS. 5-6, in step 410, responsive to determining that the first condition is satisfied (e.g., six characters have been entered into the third user interface control 510), the user device 350 may send the postal code (“K2P2L8”) to the server 300 (e.g., using the network interface 354). The user device 350 may additionally send the country (“Canada”) and/or building number (“151”) to the server 350 responsive to determining that the first condition is satisfied.

The user device 350 may send the indication and/or the other information to the server 300 in a web message, such as a web request (e.g., a HTTP request or a HTTPS request).

In step 412, the user device 350 receives, from the server 300, a response. The response may be responsive to the indication. The response may be a web response, such as a HTTP request or a HTTPS request, for example. In some examples, the information may comprise first information and the response may comprise second information based on the indication.

The first information may comprise address information and the second information may comprise one or more delivery estimates based on the address information. Each delivery estimate may comprise a respective time and/or cost. The respective time may specify how long the delivery is expected to take (e.g., 3 days, 1 day) and/or an expected arrival date and/or time. In the example described above in respect of FIGS. 5-6, in step 412, the user device 350 may receive one or more delivery estimates based on the postal code (“K2P2L8”) sent to the server 300 in step 410.

The first information may comprise a tip or donation amount and the second information may comprise an order total including the tip or donation amount. Thus, the server 300 may add the tip or donation amount indicated to the server 300 in step 410 to an existing total amount for the order to obtain an updated total amount and send a response comprising the updated total amount.

The second information may indicate that the first information is valid. For example, the first information may comprise a discount code and the response from the server 300 may indicate that the discount code is valid. In another example, the first information may comprise a quantity of product(s) (e.g., a quantity of goods) to be ordered by the user and the second information may indicate that the quantity is available (e.g., an order for that quantity would be valid). In another example, the first information may comprise one or more dates and/or times and the second information may indicate that the one or more dates and/or times are available.

The second information may be based on the stored information associated with the user described above. Thus, for example, the second information may be based on information from a profile of the user. For example, the first information may comprise address information and the second information may comprise a delivery estimate selected from a plurality of delivery estimates based on a preferred mode of delivery in a user profile.

In another example, the second information may be based on information from a session profile. For example, the first information may comprise selection of a payment via a payment service and the second information may include confirmation that the user device 350 has an ongoing session with the payment service (e.g., the user is logged into the payment service at the user device 350) that can be used for payment of the order.

In some embodiments, the method 400 may further comprise, responsive to sending the indication to the server 300 in step 410, preventing change of the information entered into the user interface control until the response is received in step 412. Thus, for example, the user device 350 may disable some or all of the user interface until the response is received. The user device 350 may disable the user interface control into which the user entered the information. Preventing change of the information entered into the user interface control until the response is received can prevent a race condition from occurring at the server 300 by preventing changed information from being sent to the server 300 before the response is received

In step 414, the user device 350 modifies at least a portion of the rendered page based on the received response. The user device 350 may thus modify at least a portion of the rendered page responsive to the response from the server 300. Processes for modifying at least a portion of the rendered page (e.g., the page rendered in step 404) are discussed in more detail below.

The user device 350 may modify at least a portion of the page to display further information received in the response from the server 300 (e.g., the second information). The further information may comprise, for example, a total order amount (e.g., a total cost or price of the order to be placed using the page). In an example, the information received via the user interface in step 406 may comprise a discount code and the response from the server 300 may comprise an updated order cost (e.g., total cost) after the discount associated with the discount code has been applied. Step 414 may comprise modifying at least a portion of the page to show the updated order cost on the display 358.

In some embodiments, modifying at least the portion of the page in step 414 may comprise modifying the portion of the page to display a second user interface control on the page. The response from the server 300 may indicate that further information should be requested from the user. The response from the server 300 may indicate the second user interface control is to be displayed.

For example, at least a portion of the page may be modified to display a second user interface control (e.g., two or more radio buttons) corresponding to two or more delivery options (e.g., showing a respective price and/or time for each of the delivery options) for the user to select one of the two or more delivery options.

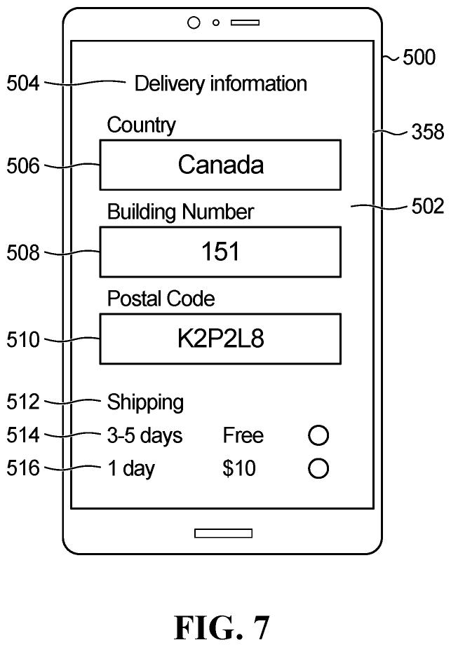

An example is illustrated with reference to FIG. 7, which shows the page 502 previously discussed in respect of FIGS. 5-6 modified according to an implementation of step 414. The page 502 has been modified to display a header (“Shipping”) 512, a first delivery option 514, and a second delivery option 516. The first and second delivery options 514, 516 may correspond to the delivery estimates received from the server in step 412. The first and second delivery options 514, 516 include a respective radio button (an example of a user interface control) and label, in which each label indicates a delivery time (“3-5 days”, “1 day”) and price (“Free”, “$10”). The user may thus select one of the two delivery options by selecting one of the radio buttons.

In another example, step 414 may comprise modifying at least a portion of the page to display a second user interface control for submitting the order (e.g., a submit order button). The response from the server 300 may indicate that the order is ready to be submitted (e.g., all of the information entered by the user is complete). Responsive to receiving the response indicating that the order is ready to be submitted, the user device 350 may modify at least a portion of the page to display a second user interface control for submitting the order.

In general, step 414 may comprise modifying the portion of the page to display further information and/or a second user interface control.

In some embodiments, modifying the portion of the page in step 404 may comprise modifying (e.g., adding, changing or deleting) a portion of the page indicative of a characteristic or parameter of the order (e.g., the order to be placed). The user device 350 may modify an element of the page indicative of a characteristic or parameter of the order. For example, user device 350 may modify a portion of the page indicative of a shipping method and/or rate. The user device 350 may modify a portion of the page indicative of one or more goods and/or services being ordered (e.g., the type and/or quantity of goods and/or services). For example, the user device 350 may modify a portion of the page to indicate that one, rather than two, blankets are to be ordered responsive to receiving, in step 412, a response indicating that only one blanket is available for order. The user device 350 may modify a portion of the page indicative of payment information and/or a payment method. For example, the user device 350 may modify a portion of the page to display one or more user interface controls for receiving payment information. The user device 350 may modify a portion of the page indicative of a transaction amount (e.g., a total price or cost of the order, an amount to be paid by the user, a price of one or more goods and/or services and/or a discount amount or rate). For example, the user device 350 may modify a portion of the page to display an order total calculated including a delivery/shipping cost based on a shipping option selected by the user.

In particular examples, step 414 may comprise modifying at least the portion of the page before a response from the server 300 is received, and possibly also even before an indication is sent to the server 300 in step 410. The user device 350 may modify at least the portion of the page responsive to determining that the information satisfies the at least one condition in step 408. The user device 350 may modify at least the portion of the page to display a second user interface control responsive to determining that the information satisfies the at least one condition. For example, the user device 350 may modify at least the portion of the page to display a second user interface control for receiving payment information in response to determining that address information received in step 406 satisfied the at least one condition in step 408. This can further reduce idling time by allowing for more information to be collected from the user whilst waiting for a response from the server, and/or (depending upon the scenario) it may allow for more information to be collected before sending the information to the server, which reduces the number of network transmissions to the server, while at the same time still performing checks (as per the one or more conditions) to ensure the information being collected is complete and/or well-formed.

In step 414, the user device 350 may modify at least a portion of the rendered page based on the received response and the stored information associated with the user described above. Thus, for example, the received response may comprise a plurality of delivery estimates and the user device 350 may identify one of the delivery estimates from the plurality of delivery estimates based on a preferred mode of delivery in a user profile. The user device 350 may, in step 414, modify at least a portion of the rendered page to display the identified delivery estimate. The other delivery estimates might not be displayed. Alternatively, the user device 350 may modify the at least a portion of the rendered page to display the plurality of delivery estimates and to display an indicator showing that the identified delivery estimate has been selected.

Changing a Focus of the Page

In some examples, the user device 350 may further change a focus of the page. For example, the user device 350 may change a focus of the page in response to receiving the response from the server 300 in step 412. In another example, the user device 350 may change a focus of the page in response to determining that the information satisfies the at least one condition in step 408. The user device 350 may change the focus possibly before a response from the server 300 is received, and possibly also even before an indication is sent to the server 300 in step 410.

The user device 350 may change a focus of the page to a part of the page modified (e.g., being modified) in step 414. Thus, for example, the user device 350 may change a focus of the page to a second user interface control to be displayed as a result of the modification in step 414. In another example, the user device 350 may change a focus of the page to further information to be displayed as a result of the modification in step 414.

The skilled person will appreciate that there are various ways in which the focus of the page may be changed. There may be regions of the display 358 upon which the user's gaze may be more likely to fall. These regions may be referred to as focus regions. As such, in some examples, the focus may be changed to a modified part of the page by placing the modified part of the page in a focus region (e.g., focus point or focal point) of the display 358. The positions of these focus regions may vary depending on the user device 350. In one example, the focus region may be the upper half of the display 358. As such, the user device 350 may change a focus of the page to a modified part of the page by positioning the modified part within the page such that it is displayed in the upper half of the display 358. This change of focus may be made apparent to the user by using one or more animations to indicate scrolling and/or zooming. In some embodiments, changing a focus of the page (e.g. to a modified part of the page) may include enabling or selecting a user interface control (e.g. in the modified part of the page) so as to direct further user input (e.g. keystrokes from a real or virtual keyboard) to the user interface control.

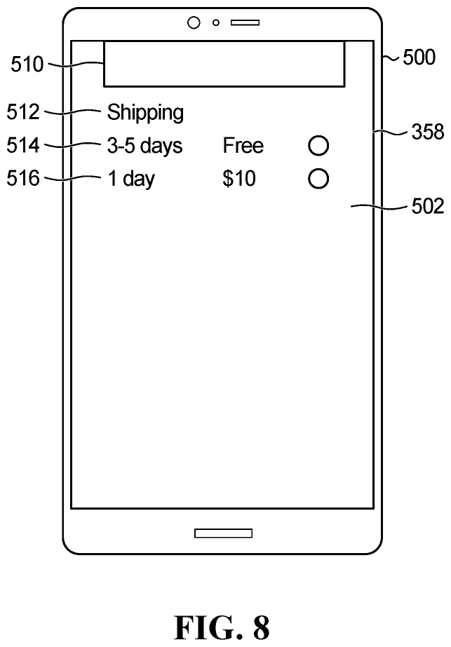

An example is illustrated by reference to FIG. 8, which shows a modified version of the page 502, in which the page 502 has been modified, in step 414, to display the header 512, first delivery option 514 and the second delivery option 516 as described above in respect of FIG. 7. In contrast to FIG. 7, the focus of the page 502 has been changed to the part of the page that includes header 512, first delivery option 514 and second delivery option 516 such that this part of the page is displayed in the upper half of the display 358.

By changing the focus of the page to the modified portion of the page, the user's attention can be drawn to a next step in the process of placing an order. For example, the focus may be changed to the next user interface control into which the user should enter information. In another example, the focus may be changed to information received from the server 300, such as an updated order total. By automatically switching a focus of the page in this manner, the user can be guided through the process of placing an order, which provides a more intuitive interface for placing an order.

Switching a focus of the page may additionally make more space available on the display 358 of the user device 350. This may be illustrated by returning to FIG. 8, which shows that switching the focus to the part of the page containing the header 512, first delivery option 514 and second delivery option 516 can free up space in the lower half of the display 358. The space made available in the lower half of the display 358 may be used to present further information and/or user interface control(s), for example. Switching the focus of the page may thus allow for using display space more efficiently, which may be particularly important for user devices with small screens (e.g., mobile phones or tablets).

Invalid Information

In some embodiments, the response from the server 300 received in step 412 may indicate that the information is invalid, despite the information possibly satisfying one or more conditions checked by the user device 350 before the user device 350 sent the information to the server 300. For example, the user device 350 may check that the digits of entered credit card information appear to be valid, but the server 300 may determine that the credit card is invalid or declined. When the response from the server indicates that the information is invalid, the user device 350 may, in step 414, modify at least a portion of the page 502 to prompt the user to change the information.

The server 300 may determine whether or not the information is valid.

Alternatively or additionally, the server 300 may send the indication to another entity and receive a response indicating whether or not the information is valid. Where conflicts arise between the determinations of the server 300 and that of other entities (i.e. about whether or not the information is valid), the server 300 may reconcile the determinations (e.g. giving primacy to its own determination, giving primacy to the determinations of other entities, or based on some other set of rules).

In the example described above in reference to FIGS. 5-6, the user device 350 may, instead of receiving the two or more delivery options, receive a response from the server 300 indicating that the information (“K2P2L8”) is invalid.

The server 300 may determine whether or not the indication received from the user device 350 is valid. For example, the server 300 may store one or more criteria (e.g., in the memory 306) regarding postal code formats for countries that could have been entered into the first user interface control 506 (e.g., countries appearing in the drop-down list). The server 300 may identify the format corresponding to the country entered by the user into the first user interface control 506 and compare the postal code entered by the user to the identified format. For example, since the user entered “Canada” in to the first user interface control 506, the server 300 may identify a format corresponding to “Canada”, specifying that the postal code should have six characters, starting with a letter selected from letters in the range A to G (an arbitrary rule chosen here for demonstration purposes). Since the first character of “K2P2L8” is K, which is outside of the range A to G, the server 300 may determine that the postal code received by the user device 350 in step 406 is invalid. In this example, it is assumed that the condition “starting with a letter selected from letters in the range A to G” was not checked by the user device 350.

Alternatively or additionally, the server 300 may receive a message indicating that the information is invalid from another entity. The server 300 may send the indication to another entity and receive, in response, a message indicating that the information is invalid. For example, the server 300 may send the address information to a shipping service, such as the shipping service 122 and expect to receive a delivery estimate in response. The shipping service may indicate, to the server 300 that the postal code entered by the user “K2P2L8” is not a valid postal code for the country entered by the user (“Canada”).

In general, the server 300 and user device 350 may work together to jointly check the information is valid. For example, the user device 350 may check “basic” conditions (e.g., postal code has six characters) and the server 300 may check more advanced conditions and/or conditions that require corresponding with a 3^{rd} party (e.g., the server 300 checks the postal code against Canada Post's valid postal codes using an API offered by Canada Post). By only having more “basic” checks performed by the user device 350, with additional more sophisticated conditions being evaluated by the server 300, fewer conditions may be sent to the user device 350 to implement. This can save network overhead and/or processing resources at the user device 350. Joint checking may be particularly advantageous for sensitive information, such as payment information, which may be verified by comparison with information that is private to the server 300 or a third party (e.g., a credit card company). For example, the server 300 may check that a credit card is valid by sending a request for validation to a payment service, which may avoid the need for the payment service to share private information. This can enable orders to be placed more securely.

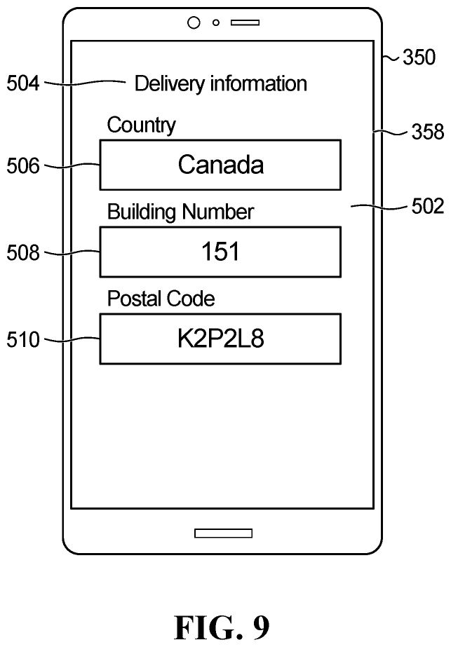

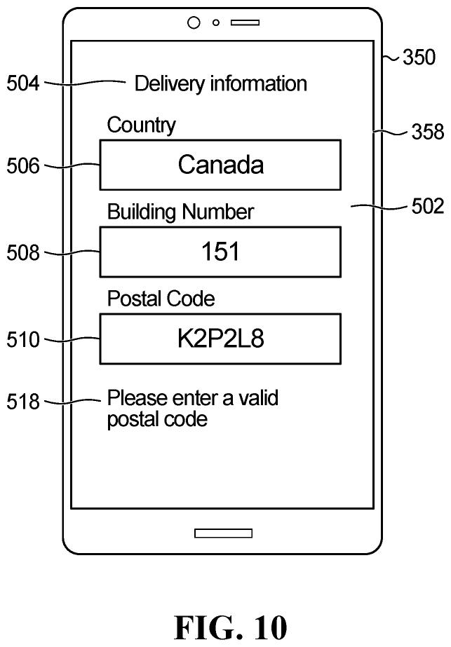

The user device 350 may thus receive a response from the server 300 indicating whether or not the information is valid. Responsive to receiving the response indicating that the information is invalid in step 412, the user device 350 may, in step 414, modify at least a portion of the page 502 to prompt the user to change the information. The user device 350 may, for example, modify at least a portion of the page 502 to display an error message indicating that indicating that the information is invalid. Thus, in the example described above in respect of FIGS. 5-6, in response to receiving the response indicating that the information (“K2P2L8”) is invalid, the user device 350 may modify the page 502, such as the page 502 shown in FIG. 9, to display an error message, such as the error message 518 shown in FIG. 10. This provides the user with an opportunity to correct the information they have entered (e.g., without needing to manually navigate to a previous page).

Processes for Modifying at Least a Portion of the Rendered Page

In some embodiments, the user device 350 may modify only a portion of the rendered page. One or more parts (e.g., one or more parts visible on the display 358) of the page may remain unchanged (e.g., might not be modified). By modifying only a portion of the page, processing at the user device 350 may be reduced. In some embodiments, the user device 350 may modify the entire page. The user device 350 may, for example, regenerate the entire page.

In some embodiments, the user device 350 may modify the at least the portion of the page without reloading the page (e.g., the entire page). In this context, loading or reloading the page may include receiving instructions for generating the page from the server 300. Loading or reloading may include retrieving instructions for generating the page from a memory of the user device 350 (e.g., from the memory 356). For example, loading or reloading may include retrieving instructions for generating the page from a cache of the user device 350. The user device 350 may thus modify the at least the portion of the page without reloading the page by modifying the at least the portion of the page without receiving any further instructions (e.g., any HTML, CSS and/or JavaScript) from the server 300. For example, the user device 350 may regenerate the at least the portion of the page (e.g., part of the page or the entire page) based on an existing DOM (e.g., a DOM tree) and/or CSSOM.

In some examples, the user device 350 may regenerate at least the portion of the page by redetermining a layout of the page (e.g., of the rendered page) and adding (e.g., painting or printing) one or more elements to page based on the redetermined layout. The layout may be redetermined in a similar manner to the determination of a layout of a web page described above. The layout may be redetermined based on a tree previously used to render the page (e.g., in step 404), for example. In examples in which only a portion of the page is regenerated, the user device 350 may add one or more elements to the page in addition to one or more existing elements in the page (e.g., without repainting the existing elements). In examples in which the entire page is regenerated, the user device 350 may add one or more elements and one or more existing elements to the page.

Although the method 400 is described as being performed by the user device 350, the present disclosure is not limited as such. In some embodiments, a user device is provided for performing the methods described above. The user device may include a memory (e.g., memory 356) to store information such as the instructions and/or the one or more conditions. The user device may further include at least one processor (e.g., processor 352) to perform operations such as the method steps described above. For example, the memory may store instructions which, when executed by the at least one processor, cause the user device to perform the method 400 described above in respect of FIG. 4.

In some embodiments, a computer-readable medium is provided having stored thereon computer-executable instructions that, when executed by a computer, cause the computer to perform the steps of the method 400 described above in respect of FIG. 4. The computer may be associated with a user device, such as the user device 350. For example, the computer may be or be a part of the user device. In an example, the computer may comprise at least one processor of the user device.

In some embodiments, a computer-implemented method is provided. The method may be performed by a server, such as the server 300, for example. The method comprises sending, to a user device, instructions which, when executed by the user device, cause the user device to perform some or all of the steps of method 400 described above in respect of FIG. 4. In particular examples, the method may comprise sending the instructions to the user device as part of content corresponding to a page for placing an order, in which the instructions, when executed by the user device, cause the user device to perform steps 404-414 of the method 400 described above. The content may be the content described above in respect of step 402 of the method 400, for example. The server method may thus comprise, for example, sending to a user device, content corresponding to a page for placing an order, in which the content including first instructions for providing a user interface for receiving information related to the order and second instructions for performing steps 404-414 of the method 400. The content may define one or more conditions associated with the user interface.

In an example, a computer-implemented method is provided. The method may be performed by a first server, such as the server 300, for example. The method comprises sending, to a user device, first instructions which, when executed by the user device, may cause the user device to render a page for display on a display associated with the user device. The page may be for placing an order and the rendered page may include a user interface for receiving information related to the order. The first instructions may further, when executed by the user device, cause the user device to receive information via the user interface and determine that the information satisfies at least one condition. The first instructions may further, when executed by the user device, cause the user device to, responsive to the information satisfying the at least one condition, send, to a second server, an indication based on the received information and receive, from the second server, a response. The response may be responsive to the indication. The first instructions may further, when executed by the user device, cause the user device to modify at least a portion of the rendered page based on the received response. The method may further comprise sending, to the user device, content corresponding to the page, in which the content including second instructions for providing the user interface. The content may further define one or more conditions associated with the user interface, in which the one or more conditions include the at least one condition. The first server may be the second server. Alternatively, the first and the second server may be different such that the server that sends the first instructions to the user device may be different to the server receiving the indication from the user device.

In some embodiments, a computer-readable medium is provided having stored thereon computer-executable instructions that, when executed by a computer, cause the computer to perform the steps of the aforementioned methods. The computer may be associated with a server, such as the server 300. For example, the computer may be or be a part of the server. In an example, the computer may comprise at least one processor of the server. In some embodiments, a server is provided for performing the aforementioned methods. The server may include a memory (e.g., memory 306) to store information such as content. The system may further include at least one processor (e.g., processor 302) to perform operations such as the method steps described above. For example, the memory may store instructions which, when executed by the at least one processor, cause the server to perform the aforementioned methods.

Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

Memory, as used herein, may refer to memory that is persistent (e.g., read-only-memory (ROM) or a disk), or memory that is volatile (e.g., random access memory (RAM)). The memory may be distributed, e.g., a same memory may be distributed over one or more servers or locations.

1. A computer-implemented method comprising:
receiving, by a user device from a server, content corresponding to a page for placing an order, the content including instructions for providing a user interface for receiving information related to the order and the content defining one or more conditions associated with the user interface;
rendering, by the user device, the page for display on a display associated with the user device, the rendered page including the user interface;
receiving information via the user interface;
determining, by the user device, that the information satisfies at least one condition of the one or more conditions;
responsive to the information satisfying the at least one condition of the one or more conditions, sending, by the user device to the server, an indication based on the received information;
receiving, by the user device from the server, a response responsive to the indication; and
modifying, by the user device, at least a portion of the rendered page based on the received response.

2. The computer-implemented method of claim 1, wherein the at least one condition comprises the information having a particular format.

3. The computer-implemented method of claim 2, wherein the particular format comprises at least one of: a particular number of characters, a particular type of one or more characters, or a position of a particular type of character in the information.

4. The computer-implemented method of claim 1, wherein the response from the server indicates that the information is invalid and modifying the portion of the page comprises modifying the portion of the page to prompt the user to change the information.

5. The computer-implemented method of claim 1, wherein the information is entered into a first user interface control displayed on the page and modifying the portion of the page comprises modifying the portion of the page to display a second user interface control on the page.

6. The computer-implemented method of claim 5, wherein the first user interface control comprises a text entry field and the information entered is entered into the text entry field.

7. The computer-implemented method of claim 5, wherein modifying the portion of the page to display the second user interface control on the page comprises changing a focus of the page to the second user interface control.

8. The computer-implemented method of claim 1, wherein the at least one condition of the one or more conditions is based on data from the user device.

9. The computer-implemented method of claim 1, wherein the information comprises address information.

10. The computer-implemented method of claim 1, wherein the information is entered into a user interface control displayed on the page, and the computer-implemented method further comprises:
responsive to sending the indication to the server, preventing change of the information entered into the user interface control until the response is received.

11. The computer-implemented method of claim 1, wherein the information is entered into a first user interface control displayed on the page and the computer-implemented method further comprises:
responsive to the information satisfying the at least one condition of the one or more conditions, changing a focus of the page to a second user interface control on the page.

12. The computer-implemented method of claim 1, wherein the content comprises web content and the page comprises a web page.

13. A computer readable medium having stored thereon computer-executable instructions that, when executed by a computer associated with a user device, causes the user device to perform operations comprising:
receiving, from a server, content corresponding to a page for placing an order, the content including instructions for providing a user interface for receiving information related to the order and the content defining one or more conditions associated with the user interface;
rendering the page for display on a display associated with the user device, the rendered page including the user interface;
receiving information via the user interface;
determining that the information satisfies at least one condition of the one or more conditions;
responsive to the information satisfying the at least one condition of the one or more conditions, sending, to the server, an indication based on the received information;
receiving, from the server, a response responsive to the indication; and
modifying at least a portion of the rendered page based on the received response.

14. The computer readable medium of claim 13, wherein the at least one condition comprises the information having a particular format.

15. The computer readable medium of claim 14, wherein the particular format comprises at least one of: a particular number of characters, a particular type of one or more characters, or a position of a particular type of character in the information.

16. The computer readable medium of claim 13, wherein the information is entered into a first user interface control displayed on the page, and wherein the computer-executable instructions, when executed by the computer, cause the user device to modify the portion of the page by performing operations including modifying the portion of the page to display a second user interface control on the page.

17. The computer readable medium of claim 16, wherein the first user interface control comprises a text entry field and the information entered is entered into the text entry field.

18. The computer readable medium of claim 16, wherein the computer-executable instructions, when executed by the computer, cause the user device to modify the portion of the page to display the second user interface control on the page by performing operations including changing a focus of the page to the second user interface control.

19. The computer readable medium of claim 13, wherein the at least one condition of the one or more conditions is based on data from the user device.

20. The computer readable medium of claim 13, wherein the information is entered into a user interface control displayed on the page, and wherein the computer-executable instructions, when executed by the computer, further cause the user device to:
responsive to sending the indication to the server, preventing change of the information entered into the user interface control until the response is received.

21. The computer readable medium of claim 13, wherein the information is entered into a first user interface control displayed on the page, and wherein the computer-executable instructions, when executed by the computer, further cause the user device to:
responsive to the information satisfying the at least one condition of the one or more conditions, changing a focus of the page to a second user interface control on the page.
